(19) United States
(12) Patent Application Publication
(10) Pub. No.: US 2010/0022281 A1
(43) Pub. Date: Jan. 28, 2010

(54) WIRELESS PHONE HEADSET

(76) Inventors: Arthur L. Cohen, Mountain View, CA (US); John M. Glissman, Valley Ford, CA (US)

Correspondence Address: STAINBROOK & STAINBROOK, LLP, 412 AVIATION BOULEVARD, SUITE H, SANTA ROSA, CA, 95403, US

(21) Appl. No.: 11/720,837

(22) PCT Filed: Jan. 5, 2006
(86) PCT No.: PCT/US06/00463

§ 371 Date: Jun. 4, 2007

Related U.S. Application Data
(60) Provisional application No. 60/641,891, filed on Jan. 5, 2005.

(51) Int. Cl. H04M 1/00

(52) U.S. Cl. 455/569.1

(57) ABSTRACT

A wireless phone headset for cell and office phone systems, including a flexible headband having an integral annulus on one end of the headband adapted for placement over and around a user's ear. An earpiece/microphone combination is provided and has an annular portion swivelingly connected to the headband annulus using the swiveling connection means. The headset also includes an electronics housing with a base portion integral with the earpiece/microphone member and extending inwardly from said annular portion of said earpiece/microphone annulus into the generally open interior area region formed by the annular portion. The base portion has an interior side and a cover that combine to create an open interior space for housing electronic elements. An earpiece is disposed on the interior side of the base portion. A microphone boom extends outwardly from the electronics housing and a microphone is provided at the end of the boom.

### BACKGROUND OF THE INVENTION

1. Technical Field

The present invention relates generally to wireless headsets, and more particularly to a wireless headset to provide hands free use of cellular telephones and office phone systems.

2. Background Art

Cellular telephones are rapidly becoming the dominant means of telephonic communications. The freedom from wire-based systems provided by cell phones has enabled individuals to communicate with others while engaged in other activities, such as driving, walking, or (regrettably) eating. Studies are inconclusive on the dangers of talking on a cell phone while driving, but it is undeniable that having one hand and arm occupied with something other than vehicle control is less than perfectly safe. Accordingly, it is desirable to have means of using a cell phone while keeping both hands free to steer, shift gears, and manipulate buttons and knobs controlling various vehicle systems and devices, such as heaters, defrosters, mirror settings, and the like. Thus, reduce the risk of traffic accidents and to provide users with a more comfortable and convenient way to communicate with both hands free, several companies are manufacturing and selling phone headsets, some of which are adapted for use with wireless land phones, but some of which are also adapted for use with cell phones. A common alternative for use in the automobile is a phone speaker system.

Most current cell phone headset designs require a wired connection to a cell phone. The headset is plugged into an audio output jack and the cell phone is then placed in a convenient location. When driving, it is common to place the phone in one's lap, the adjacent seat, or an installed phone cradle. The wire provides a secure connection to the phone, and generally clear audio output, but the wire can pose as many problems to replace those purportedly solved by the headset. It can vex and annoy the user simply by being in the way—brushing across the face, dangling in front of and across the neck and arms. It can snag and suddenly pull the headset from the user's head, sometimes eliciting a grab response from the user, and this can be quite dangerous when it happens to the driver of a moving vehicle.

The most broadly marketed and widely adopted designs for wired and wireless headsets are of three types, including ear buds, over-the-ear, and headband-type. The first design, ear buds, include a speaker or pair of speakers disposed in small cylindrical housings inserted into the user's auditory canal. The housing is held in place only by the friction and pressure exerted on the user's auditory canal, and therefore it can be very uncomfortable and can easily be ejected or dislodged. Additionally, it has recently come to light that ear buds may cause hearing damage due to the retention of air pressure within the ear while in use. Further, ear buds are generally quite small and incapable of encasing the power source for driving the speakers. Therefore power is typically supplied through a wired connection to a base unit.

The second type of design, over-the-ear headsets, typically comprise an ear-clip type earpiece designed to be placed on, over, and at least partially around the user's ear. The earpiece includes a speaker held against and slightly inside the ear when the earpiece is placed on the outside of the user's ear. This type of headset generally solves the problem of discomfort, but they are not significantly more secure than ear buds. Further, they are generally adapted for use on only one ear (right or left), and they can be awkward and cumbersome to install.

A third design type comprises what are known as over-the-head headsets. These headsets typically employ a resilient arcuate head band which holds a speaker against, but outside, the user's ear. While generally slightly larger in size and weight, the headband type design is significantly more secure than either the ear bud or over-the-ear designs. The added security provides a measure of design flexibility in the placement of heavy electronics and power supplies. However, prior art designs generally provide an ear piece firmly pressed against the ear by the arcuate flexible headband, and after a period of use, this can become quite uncomfortable. Further, the known prior art designs do not disclose, teach, suggest, show, or otherwise render obvious a wireless headset having a selective on-off switch for the earpiece, an auto-off power saving circuit for the transmitter, or an auto-on/auto-off circuits for the transmitter.

### Disclosure of Invention

The object of the present invention is to provide a wireless headset that enables cell phone users to talk hands free and without wires while driving or while engaged in any physical activity in which use of a conventional headset would be either dangerous or cumbersome. It provides a low cost solution to the problem of driving with a hand held cell phone.

Other novel features characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration and description only and are not intended as a definition of the limits of the invention. The various features of novelty which characterize the invention are pointed out with particularity in the claims annexed to and forming part of this disclosure. The invention resides not in any one of these features taken alone, but rather in the particular combination of all of its structures for the functions specified.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view showing the wireless headset of the present invention, as worn by a user;

FIG. 2 is an exploded perspective view showing the two major components of the inventive apparatus;

FIG. 3 is an interior side view in elevation of the earpiece and boom mike portion of the headset;

FIG. 4 is an exterior side view in elevation of the earpiece and boom mike portion;

FIG. 5 is an upper rear perspective view of a miniature wireless RF transmitter for use with the inventive headset;

FIG. 6 is an upper front perspective view of the miniature RF transmitter;

FIG. 7 is a perspective view showing a portion of the cover for the earpiece and boom mike; and

FIG. 8 is a perspective view showing the power and switching components of the headset.

### BEST MODE FOR CARRYING OUT THE INVENTION

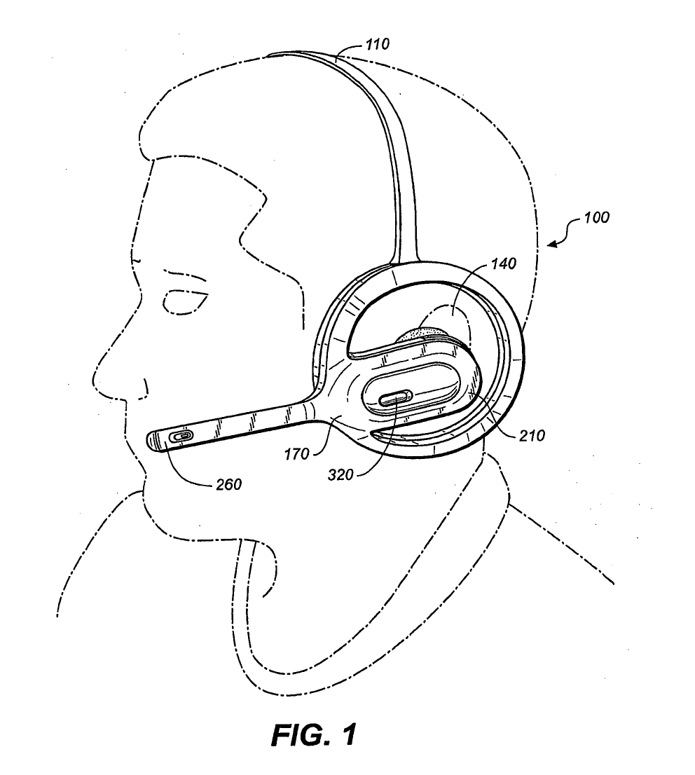

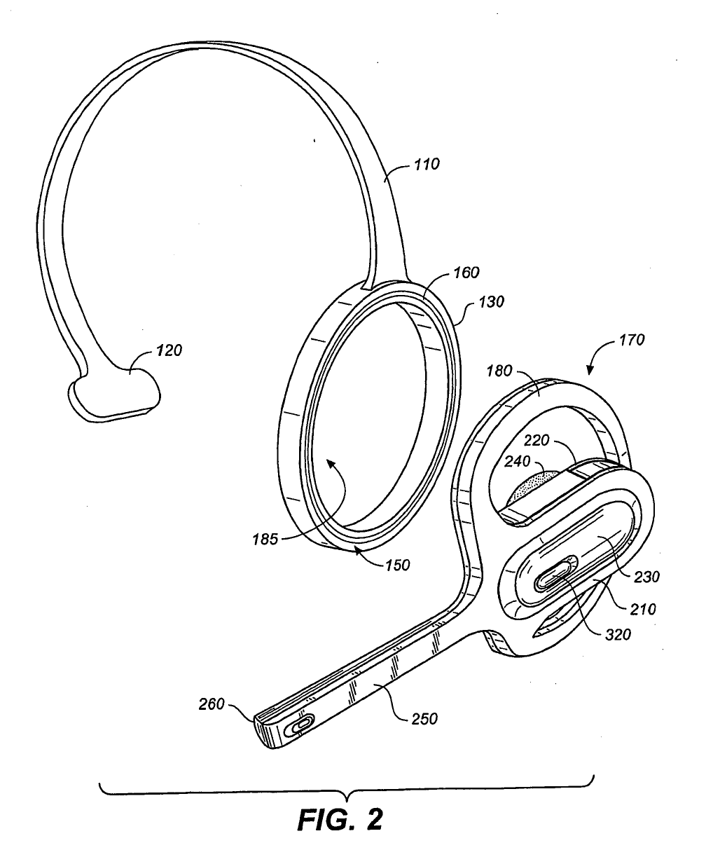

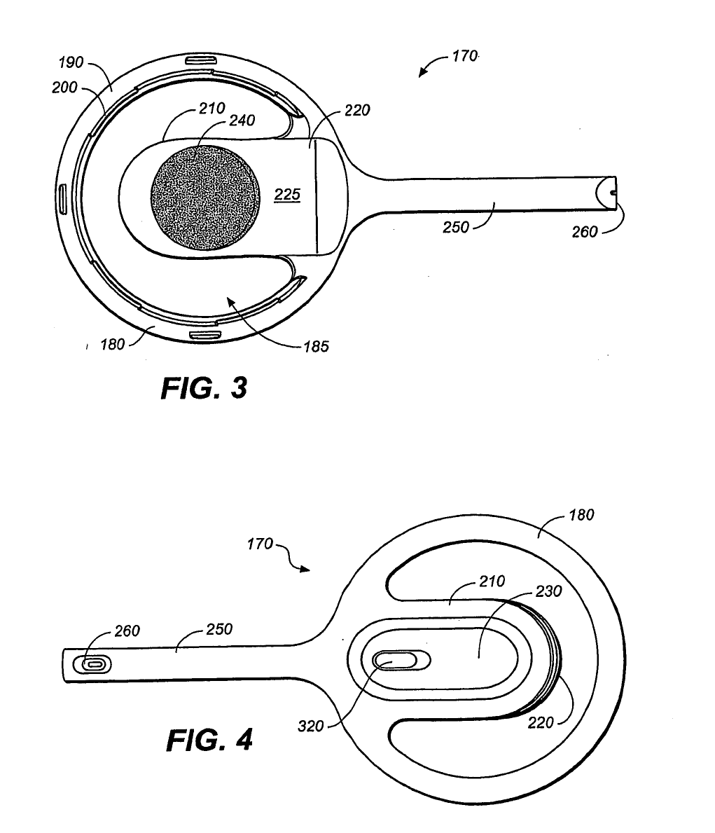

Referring to FIGS. 1 through 8, wherein like reference numerals refer to like components in the various views, there is illustrated therein a new and improved wireless phone headset for use with cell and office phone systems, generally denominated 100 herein.

FIGS. 1-4 illustrate a first preferred embodiment of the inventive headset, showing that the headset comprises a flexible arcuate headband portion 110 having an oblong expansion 120 on one end, preferably padded, and a headband annulus or ring 130 on the other end. The headband is generally placed over the user's head, though it possess sufficient holding power to support the electronic elements when placed underneath the external occipital protuberance at the top of the neck. The annulus 130 disposed on the end is adapted for placement over and around a user's ear 140.

The exterior side 150 of the headband annulus includes a channel 160 or other connection means adapted for swiveling connection to a combination earpiece/microphone member 170.

In the first preferred embodiment, the earpiece/microphone member includes an annular portion 180 having an interior surface 190 with connection means 200, preferably a plurality of projections or tongues 200, for matable snap-fit insertion into the channel 160 of the headband annulus. The annular portion forms a generally open interior area 185. Accordingly, the earpiece/microphone member may be rotated 360 degrees about the headband annulus. Numerous alternative means of coupling the headband annulus to the headset housing annulus are possible, including magnet surface-to-surface contacts, complementary hook and loop fastener material on each annulus surface, bayonet mounts, and so forth.

The earpiece/microphone member further includes an electronics housing 210 having a base portion 220 integral with the earpiece/microphone and extending inwardly from the annular portion of the earpiece/microphone annulus to the generally open interior area region 185 formed by the annular portion 180, and a cover portion 230 which snaps onto the base portion to create the open interior space or volume which houses the antenna, receiver, and transmitter electronics of the apparatus, none of which are described in detail in this application as all are well known in the art.

The earpiece/microphone member further includes a padded earpiece 240 disposed on the interior side 225 of the base portion and through which audio output is delivered by an earpiece speaker (not shown). A microphone arm or boom 250 extends outwardly from the housing, and a microphone 260 is disposed at the end of the boom and is in electronic communication with the transmitter electronics contained with the electronics housing 210.

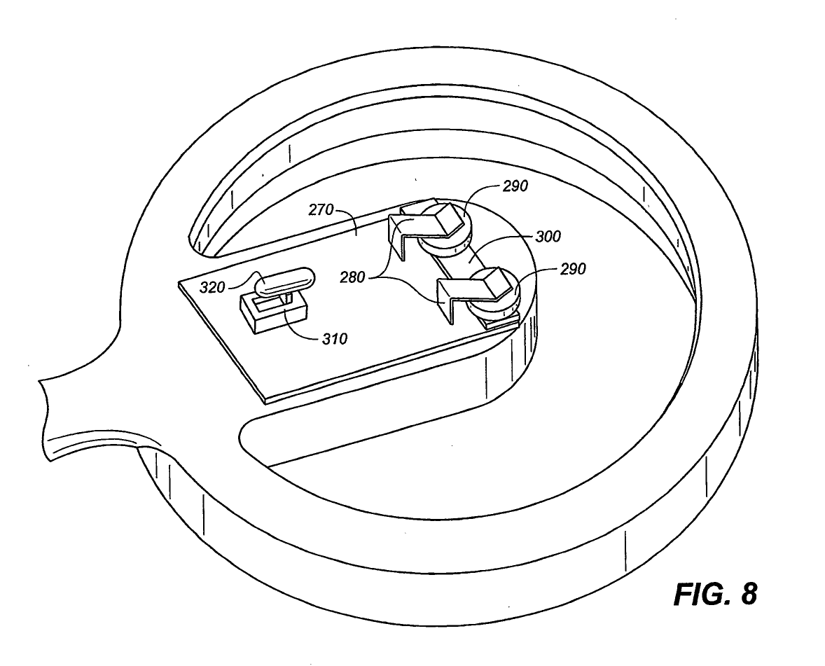

Referring now to FIG. 8, the base portion 220 provides a platform for securing a printed circuit board (PCB) 270 with both receiver and transmitter components. The PCB includes spring contacts 280 which capture and urge batteries 290 into electrical contact with a fixed contact 300 in the base portion. A double pole double throw switch 310 having either a sliding or push button 320 extends outside the cover portion 230 and selectively activates and deactivates the headset to permit or prohibit both transmission and/or reception. The headset receiver may employ an improved FM headset receiver circuit as shown and described in previously filed and commonly owned U.S. Utility patent application Ser. No. 11/033,230 (Pub. No. US-2005-0152535-A1), entitled, Headphone Receiver Apparatus for Use with Low Power Transmitters, incorporated in its entirety by reference herein. Accordingly, the headset is well adapted for use with the low power RF transmitters suitable for use in connection with cell phones.

FIG. 7 shows an alternative possible base portion 330 configured with snap fit elements 340, 350, for connection to a compatibly designed cover portion.

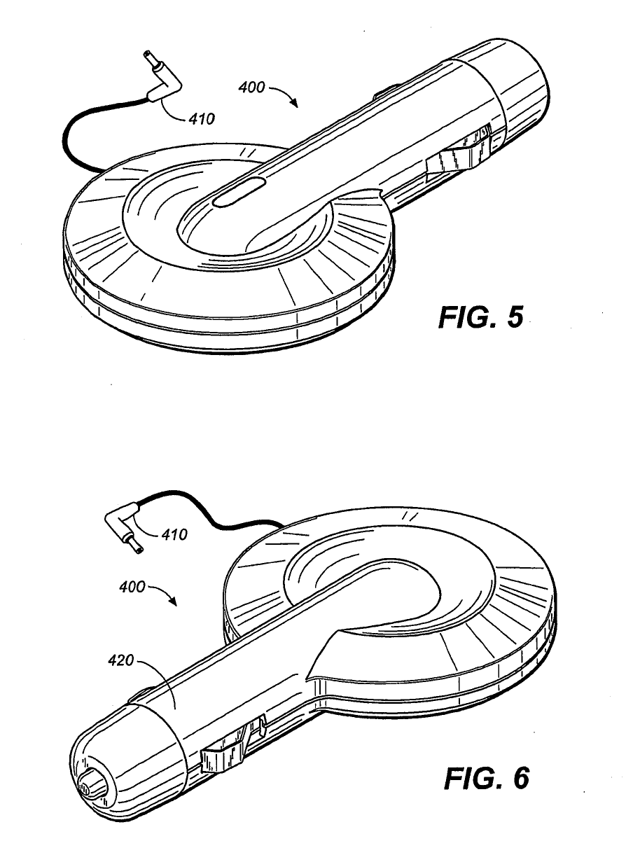

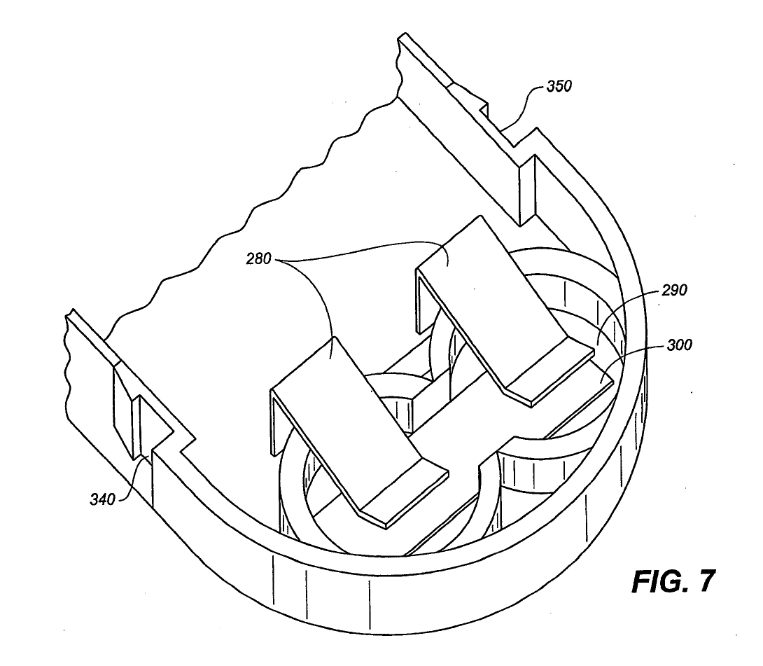

The inventive headset is intended for use with miniature RF transmitters 400, of the type shown in FIGS. 5 and 6. The transmitter includes a plug that inserts into the audio output jack (headphone jack) of a base unit, such as a cell phone, cordless telephone, or an audio device, such as an MP3 player or CD player. It is powered by batteries or through a cigarette lighter adapter circuit (CLA) housed in the cylindrical portion 420 sized for insertion into a vehicle's cigarette lighter receptacle. This device converts the audio output signal from the cell phone into an RF signal for transmission to the headset receiver; in turn it conveys RF signals from the headset transmitter to the cell phone for transmission as an outgoing cell phone signal.

The miniature RPF transmitter is preferably of the kind described in U.S. Utility patent application Ser. No. 10/540,070 (International Patent Application Ser. No. PCT/US04/00452, International Publication No. WO 2004/064026 A3), titled Circuit and Method for Providing an Auto-Off and/or Auto-On Capability for an Audio Device. The headset earpiece/microphone member may also include the circuit disclosed in this application. Additionally, both the transmitter and the headset electronics may include an auto-off circuit, such as that described in U.S. patent application Ser. No. 10/754,148 (Pub. No. 2004/0140846 A1), entitled, Circuit and Method for Providing an Auto-Off Capability for a Wireless Transmitter. Each application is incorporated in its entirety by reference herein. These previously filed and commonly owned applications disclose power saving circuits, the first showing an instant auto-on capability for the unit when a call is received and auto-off capability for the transmitter when the user is no longer speaking, and the second showing only an auto-off circuit.

The foregoing disclosure is sufficient to enable those with skill in the relevant art to practice the invention without undue experimentation. The disclosure further provides the best mode of practicing the invention now contemplated by the inventor.

While the particular wireless phone headset herein shown and disclosed in detail is fully capable of attaining the objects and providing the advantages stated herein, it is to be understood that it is merely illustrative of the presently preferred embodiment of the invention and that no limitations are intended concerning the detail of construction or design shown other than as defined in the appended claims. Accordingly, the proper scope of the present invention should be determined only by the broadest interpretation of the appended claims so as to encompass obvious modifications as well as all relationships equivalent to those illustrated in the drawings and described in the specification.

What is claimed as invention is:

1. A wireless phone headset for use with cell and office phones having a headphone jack, comprising:
a flexible headband;
a headband annulus integrally disposed on one end of said headband and adapted for placement over and around a user's ear, said headband annulus having swiveling connection means;
an earpiece/microphone member having an annular portion swivelingly connected to said headband annulus using said swiveling connection means, said annular portion forming a generally open interior area;
an electronics housing having a base portion integral with said earpiece/microphone member and extending inwardly from said annular portion of said earpiece/microphone annulus into the generally open interior area region formed by said annular portion, said base portion having an interior side and a cover portion which snaps onto said base portion to create an open interior space for housing electronic transmitter and receiver elements;
an earpiece disposed on said interior side of said base portion;
a microphone boom extending outwardly from said electronics housing and having an outer end; and
a microphone disposed at said outer end of said boom, said microphone being in electronic communication with the transmitter electronics contained in said electronics housing.

2. The apparatus of claim 1, further including an RF transmitter having a plug for insertion into the headphone jack of the cell phone.

3. The apparatus of claim 2, wherein said RF transmitter unit includes a power saving auto-off circuit.

4. The apparatus of claim 2, wherein said RF transmitter includes a power saving auto-on/auto-off circuit.

5. The apparatus of claim 1, wherein said headband is generally arcuate and includes a padded expansion on one end.

6. The apparatus of claim 1, wherein said headband annulus has an exterior side and said swiveling connection means comprises a channel in said exterior side.

7. The apparatus of claim 6, wherein said earpiece/microphone annulus includes an interior surface with projections for matable snap-fit insertion into said channel in said headband annulus.

8. The apparatus of claim 1, wherein said headband annulus and said earpiece/microphone annulus are swivelingly connected with magnet surface-to-surface contacts.

9. The apparatus of claim 1, wherein said earpiece/microphone member includes a receiver with auto-off capability.

10. The apparatus of claim 1, wherein said earpiece/microphone member includes a receiver with auto-on/auto-off capabilities.

11. The apparatus of claim 1, wherein headset includes a receiver with an instant auto-on circuit which automatically activates the headset when a call is received, and an auto-off circuit which turns off the headset when the transmitter is not in use.
